(19) United States
(12) Patent Application Publication
(10) Pub. No.: US 2010/0040737 A1
(43) Pub. Date: Feb. 18, 2010

(54) EGG PRODUCTS WITH COMPONENTS RECOGNIZED FOR REDUCING THE LEVELS OF CHOLESTEROL IN PEOPLE AND/OR IMPROVING THEIR HEALTH

(75) Inventors: David Radlo, Bedford, MA (US); Anthony Delio, Hopewell, NJ (US)

Correspondence Address: BUCHANAN, INGERSOLL & ROONEY PC, POST OFFICE BOX 1404, ALEXANDRIA, VA, 22313-1404, US

(73) Assignee: Radlo Foods LLC, Watertown, MA (US)

(21) Appl. No.: 12/369,845

(22) Filed: Feb. 12, 2009

Related U.S. Application Data
(60) Provisional application No. 61/028,501, filed on Feb. 13, 2008.

(51) Int. Cl. A23L 1/29; A23D 9/007; A23L 1/302; A23L 1/304

(52) U.S. Cl. 426/72; 426/611

(57) ABSTRACT

A novel food composition is provided in which eggs whites are combined with phytosterols. Other ingredients, such as omega-3 fatty acids, preferably including eicosapentaenoic acid (EPA) and docosahexaenoic acid (DHA), may also be present in the product. Methods for producing these compositions are also provided.

### CROSS-REFERENCE TO PRIORITY APPLICATIONS

This application claims priority to U.S. Provisional Application No. 61/028,601, file Feb. 14, 2008, hereby expressly incorporated by reference in its entirety and is assigned to the assignee hereof.

### FIELD OF THE INVENTION

This invention relates to liquid egg white products containing phytosterols and/or omega-3 fatty acids, and optionally one of the following additional components: flavonoids (especially a polymethoxylated flavonoid-tocotrienol complex, such as one marketed by Source One Global under the tradename Sytrinol™), vitamins, minerals, fiber, and lutein, as well as other components recognized for reducing the levels of cholesterol in people and/or improving their health. This invention also relates to methods for producing liquid egg white products containing phytosterols and/or flavonoids (especially a polymethoxylated flavonoid-tocotrienol complex, such as one marketed by Source One Global under the tradename Sytrinol™) and optionally one or more of the following additional components: at least one omega-3 fatty acid, vitamins, minerals, fiber, and lutein, as well as other components recognized for reducing the levels of cholesterol in people and/or improving their health.

### BACKGROUND OF THE INVENTION

In recent years there has been an increased focus by consumers in eating healthy foods. Food producers have responded by providing a variety of food products aimed towards various aspects of healthy foods. One of the major health issues directly related to food is the levels of cholesterol and related HDL and LDL levels in people's blood. It has been found that the consumption of phytosterols can provide a benefit to the health of people by reducing the levels of cholesterol. Cholesterol is found in animals and humans while phytosterols occur only in plants. Cholesterol is a very important molecule in animals and humans, serving as a vital constituent of cell membranes and a precursor to various biomolecules. Phytosterols serve similar functions in plants. It has been found that various materials can be added to food products to aid in reducing the levels of cholesterol in people and/or improving their health.

### Phytosterols

Phytosterols, also known as plant sterols, are a naturally occurring class of compounds found in the cells and membranes of plants. Phytosterols is a term often used to encompass both plant-derived sterols and stanols. Phytosterols have a molecular structure similar to dietary and endogenously produced cholesterol. The most abundant phytosterols (sitosterol, campesterol, and stigmasterol) differ from cholesterol only in the identity of one side chain or the presence of an extra double bond.

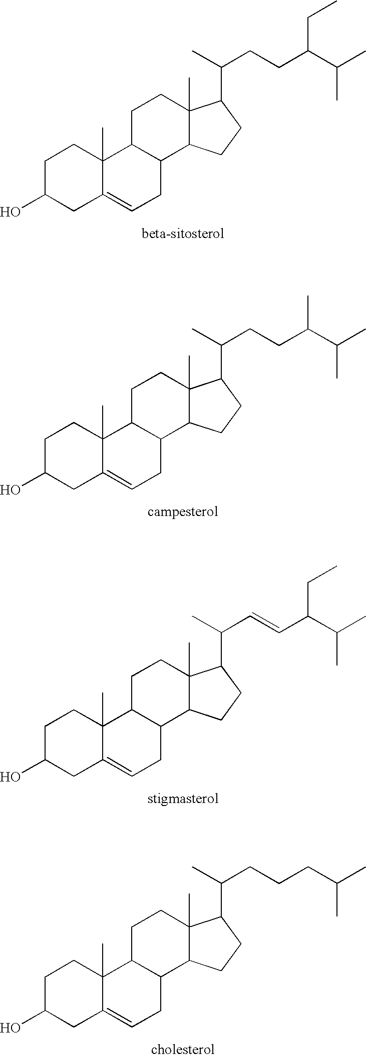

Phytostanols are a fully-saturated subgroup of phytosterols and therefore do not contain double bonds. There are four general forms of phytosterols: free phytosterols, free phytostanols, esterified phytosterols and esterified phytostanols. The term phytosterols, as used herein refers to the four general forms either individually or collectively. All four of the forms have been recognized as having the ability to lower cholesterol levels and may be used in the compositions described below.

### Sources of Phytosterols

The majority of phytosterols available today are derived from vegetable oil processing. Crops primarily processed for vegetable oil, like canola, cottonseed, corn and soybean, are major sources of phytosterols. Phytosterols are also found in nuts and various legumes. An alternative commercial source is tall oil, a by-product of paper mills. Phytostanols occur in trace levels in many plant species but are only found in high levels in a few cereal species. Phytostanols are produced from plant-derived sterols by the hydrogenation of the double bond in the sterols to eliminate any double bonds present in the molecule. Plant sterol esters or stanol esters are plant sterols or stanols that have been esterified by creating an ester bond between a fatty acid and the sterol or stanol. Esterification makes plant sterols and stanols softer in texture and more fat-soluble or dispersible so they are easily incorporated into fat containing foods, like margarines and salad dressings.

### Phytosterols and the Human Diet

Phytosterols are found in vegetables and nuts, as well as other foods, but are not present in quantities necessary to exert health benefits. The current western diet is estimated to include 200-300 mg phytosterols per day, while vegetarian and Japanese diets include a larger quantity, 300-500 mg per day. It is commonly accepted that approximately 1 g per day is required to have a serum cholesterol lowering effect. Therefore supplementing ones diet with phytosterols is essential to providing the necessary amounts of phytosterols needed to have an effect on one's health.

In the US, plant sterols and stanols added to a variety of food products are generally recognized as safe (GRAS) by the FDA. (Food and Drug Administration. GRAS Notice No. GRN 000112. 2003. See: http://www.cfsan.fda.gov/˜rdb/opa-g112.html.) Additionally, the Scientific Committee on Foods of the EU concluded that plant sterols and stanols added to various food products are safe for human use (Scientific Committee on Food. Opinion on Applications for Approval of a Variety of Plant Sterol-Enriched Foods. 2003. See: http://europa.eu.int/comm/food/fs/sc/scf/out 174_en.pdf). However, the Committee recommended that intakes of plant sterols and stanols from food products should not exceed 3 grams per day. An association in the United Kingdom, the Institute of Food Science & Technology published an information statement in June, 2000, stating their belief that phytosterols and phytostanols are both effective at reducing serum cholesterol. A dose of approximately 1 g per day, is suggested for both forms. The PDR for Nutritional Supplements (1st. ed.) has concluded that phytosterols and phytostanols are equally capable of reducing cholesterol levels. More recent work has also shown free phytosterols and free phytostanols to lower LDL cholesterol in an equivalent fashion. Given that phytosterol and phytostanol esters are reduced to the free phytosterols and phytostanol after ingestion, it is not surprising that phytosterol esters and phytostanol esters have also been reported as equally efficacious.

This current invention relates to the fortification of liquid egg products with phytosterols and one or more of other materials known to be useful in promoting or maintaining good health including omega-3 fatty acids, vitamins, minerals and flavonoids. The precise level of fortification is dependant upon the specific material used, but combination of such materials are uniquely selected to provide a synergistic benefit which is greater than benefit that could be realized by ingestion of the individual material. In a preferred embodiment, the level of these compounds must be sufficient to substantiate a claim to a specific health benefit.

### Flavonoids and Flavonoid Complexes

Flavonoids are a group of compounds that are ubiquitous in nature and occur in fruits, vegetables and beverages (tea, coffee, beer, wine and fruit drinks). Flavonoids is a term relating to family of organic compounds known as secondary plant metabolites. There three basic groups of compounds in the flavonoid family:
flavonoids, derived from 2-phenyl chromen-4-one (2-phenyl-1,4-benzopyrone)
isoflavonoids, derived from 3-phenylchromen-4-one (3-phenyl-1,4-benzopyrone)
neoflavonoids, derived from 4-phenylcoumarine (4-phenyl-1,2-benzopyrone).

Flavonoids are thought to have beneficial effects on human health as they have been reported to have antiviral, anti-allergic, antiplatelet, anti-inflammatory, antitumor and antioxidant properties. Research has shown that flavonoids play important roles in promoting health in mammals, and are most widely known for their antioxidant properties. Several important types of flavonoids have been identified and provide the following health benefits:
Epicatechin may improve blood flow and be useful in promoting cardiac health. Cocoa, the major ingredient of dark chocolate, contains relatively high amounts of epicatechin and has been found to have nearly twice the antioxidant content of red wine and up to three times that of green tea in in-vitro tests.
Proanthocyanidins extracts demonstrate a wide range of pharmacological effects including increasing intracellular vitamin C levels, decreasing capillary permeability and fragility, scavenging oxidants and free radicals, and inhibiting destruction of collagen.
Citrus bioflavonoids include hesperidin, quercetin, rutin (a glycoside of quercetin), and tangeritin. Quercetin has demonstrated significant anti-inflammatory activity because of direct inhibition of several initial processes of inflammation. It is known to inhibit the production and release of histamine and other allergic/inflammatory mediators. Quercetin exerts potent antioxidant activity and vitamin C-sparing action and is being evaluated for potential use against cancer. Quercetin can also inhibit reverse transcriptase, part of the replication process of retroviruses, although the therapeutic relevance of this inhibition has not yet been established. Rutin and hesperidin, in addition to possessing antioxidant activity and an ability to increase intracellular levels of vitamin C, exert beneficial effects on capillary permeability and blood flow. They also exhibit some of the anti-allergy and anti-inflammatory benefits observed from the use of quercetin. Hydroxyethylrutosides (HER) have been used in the treatment of capillary permeability, easy bruising, hemorrhoids, and varicose veins.
Green tea flavonoids are potent antioxidant compounds, thought to reduce incidence of cancer and heart disease and r promote the burning of fat. The major flavonoids in green tea are the catechins (catechin, epicatechin, epicatechin gallate, and epigallocatechin gallate (EGCG)).
Grape skins contain significant amounts of flavonoids as well as other polyphenols™. Both red and white wine contain flavonoids; however, since red wine is produced by fermentation in the presence of the grape skins, red wine has been observed to contain higher levels of flavonoids, and other polyphenolics such as resveratrol.
Soy and other legumes contain isoflavones, a group of compounds closely resembling the human hormone estrogen, and associated with reducing blood cholesterol levels, promoting vascular elasticity, and reducing the symptoms of menopause, dementia and benign prostatic dysplasia.

It has been recently shown that use of a complex of a polymethoxylated flavonoid in combination with a tocotrienol, marketed by Source One Global under the tradename Sytrinol™, results in a synergistic effect for significantly lowering total cholesterol, LDL cholesterol, and triglyceride levels. Research has shown that daily use of 300 mg of Sytrinol™ may lower trigycerides by 34% and cholesterol by 30%. Sytrinol™ has also been shown to increase HDL levels. Sytrinol™ is a proprietary extract of polymethoxylated flavones, including nobiletin and tanigeretin, from citrus (tangerine peel) and tocotrienols, members of the vitamin E family, from palm fruits.

The precise level of fortification of flavonoids in the composition is dependant upon the specific class of flavonoids used. In a preferred embodiment, the level of these compounds must be sufficient to substantiate a claim to a specific health benefit. A variety of flavonoids or flavonoid complexes can be used in the composition of the current invention. An example of such a complex a polymethoxylated flavonoid-tocotrienol complex is one marketed by Source Natural under the tradename Sytrinol™.

### Omega-3 Fatty Acids

There has also been increasing interest in the use of omega-3 fatty acids for the prevention and management of cardiovascular disease, as well as other health benefits. Omega-3 fatty acids are found primarily in fish and fish oils, with eicosapentaenoic acid (EPA) and docosahexaenoic acid (DHA) being two specific omega-3 fatty acids known for having an affect on cardiovascular care. Omega-3 fatty acids also exist in plants, but they are mainly present in the form of α-linolenic acid (ALA or LNA), which is only partially converted to EPA and DHA.

The recommended minimum levels for EPA+DHA are at least about 0.65 g/day, preferably about 1 g/day. However the mean daily intake of EPA+DHA in a typical North American diet is only 0.13 g/day, or approximately 0.15% of the total dietary fat intake. This deficiency may be improved by increasing fish consumption and/or consuming fish oil.

However, many people find fish to have a “fishy” taste which militates against increased fish content in the diet. There is also a perception that fatty fish consumption is fattening. In addition, capsules of fish oil are sometimes found unacceptable for swallowing by many people. In addition, fish oil capsules can induce fishy tasting burpings, which many people find unpleasant, and nauseous.

Omega-3 fatty acids from any source can be used in the compositions of the current invention. Common sources include, but are not limited to, fish oil, algae and plant oils, such as flax, walnuts, soy, etc.

### Vitamins and Minerals

It is well known to the ordinary person that various vitamins and minerals can be taken to promote good health. Information on vitamins and minerals can be found in a variety of sources including the NIH (http://www.nlm.nih.gov/medlineplus/vitamins.html) and the FDA. Vitamins and minerals can be used individually or by using a premix of several vitamins and/or minerals. In a preferred embodiment of the invention, a mixture of vitamins and minerals is used. In a more preferred embodiment the premix listed below is used in the egg white product at a rate of about 150 mg of premix per serving size of egg white product, which is encompassed by 60 grams of egg white product. A preferred premix has a composition shown below, where the addition of about 150 mg of premix provides the following minimum nutrient levels per serving.

| | | | | % |
|---|---|---|---|---|
| | | Min. | | Daily |
| Nutrient | Form | Level | Units | Value |
| Vitamin A | Natural beta-carotene | 750 | IU | 15% |
| Vitamin E | dl-alpha tocopheryl acetate | 7.50 | IU | 25% |
| Niacin | Niacin | 2.00 | mg | 10% |
| Vitamin B1 | Thiamine Mononitrate | 0.06 | mg | 4% |
| Vitamin B2 | Riboflavin | 1.02 | mg | 60% |
| Vitamin B6 | Pyridoxine Hydrochloride | 0.20 | mg | 10% |
| Pantothenic Acid | d-calcium pantothenate | 2.00 | mg | 20% |
| Folate | Folic acid | 100.0 | meg | 25% |
| Vitamin B12 | Cyanocobalamin | 5.40 | mcg | 90% |
| Calcium | Calcium phosphate | 20.0 | mg | 2% |
| Zinc | Zinc sulfate | 1.20 | mg | 8% |
| Iron | Ferric orthophosphate | 1.44 | mg | 8% |

### Vitamin E

Vitamin E is a fat-soluble vitamin that exists in eight different forms. Each form has its own biological activity, which is the measure of potency or functional use in the body. Alpha-tocopherol (α-tocopherol) is the most active form of vitamin E in humans. It is also a powerful biological antioxidant. Vitamin E in supplements is usually sold as alpha-tocopheryl acetate, a form of alpha-tocopherol that protects its ability to function as an antioxidant.

Antioxidants such as vitamin E act to protect your cells against the effects of free radicals, which are potentially damaging by-products of energy metabolism. Free radicals can damage cells and may contribute to the development of cardiovascular disease and cancer. Studies are underway to determine whether vitamin E, through its ability to limit production of free radicals, might help prevent or delay the development of those chronic diseases. Vitamin E has also been shown to play a role in immune function, in DNA repair, and other metabolic processes. Compositions of the current invention can comprise between about 30 to 400 IU of Vitamin E as either alpha-tocopherol or any other form of vitamin E.

### Fiber

Dietary fiber is a complex mixture of plant materials that are resistant to breakdown (digestion) by the human digestive system. There are two major types of dietary fiber: (1) insoluble fiber (cellulose, hemicellulose, and lignin) and (2) soluble fiber (gums, mucilages, pectin). Insoluble fiber is most frequently found in whole-grain products such as whole-wheat bread. Soluble fibers, the fiber type relevant to this current use, is typically found in certain fruits, vegetables, dry beans and peas, and some cereals such as oats and barley.

The health benefits of fiber in the diet have been widely studied and are generally considered to be an essential part of an overall healthy diet. Health benefits associated with consumption of dietary fiber are wide ranging and include:
Preventing of constipation and promoting health bowel movement
Lowering the incidence of digestive disorders including hemorrhoids, irritable bowel syndrome and diverticular disease.
Reducing blood cholesterol levels by absorbing and thus inactivating bilatory enzymes required for cholesterol absorption in the intestine and suppressing synthesis in the liver
Maintaining healthy blood sugar levels by reducing or retarding the absorption of dietary sugar. Certain studies have even shown that diets high in fiber may reduce the risk of developing Type 2 diabetes.
Reducing appetite, increasing satiety (or the feeling or fullness) and reducing caloric intake though multiple mechanisms that include increased digestive time and the promotion of hormones that signal fullness to the brain.
Reducing the risk of certain types of cancer. While study results vary, it is generally recognized that fiber, particularly soluble fiber promotes colonic health by promoting the production of healthy flora and micronutrients and lowering pH in the colon.

Current recommendations by public health officials and other accredited medical associations suggest that adults typically consume 21-38 grams of dietary fiber per day, depending on age and gender. The US Food and Drug Administration has established 30 grams as the Daily Reference Value (or DRV) for Fiber. Yet according to the USDA, the average intake of dietary fiber in Western diets is about 12 grams per day in women 19 to 50 years of age, and approximately 17 grams per day in men the same age. Public education and other awareness programs have been largely ineffective in shifting behavior to consumption of foods naturally high in dietary fiber. Thus there is a compelling need and indeed a health imperative to find alternative ways to increase dietary fiber.

This invention relates to the fortification of liquid egg products with dietary fiber, and specially soluble dietary fiber, to levels between 2.5 and 7.5 grams per 60 gram serving (approximately equivalent to one whole medium sized egg), solely on its own and in combination with other nutrients including plant phytosterols and/or omega-3 fatty acids, and/or vitamins and minerals and/or certain flavonoids; and allowing certain nutritional claims to be made about the resultant liquid egg food product including nutrient content claims of between 2.5 to 7.5 grams of fiber per serving, and/or “good” and/or “excellent source of fiber” as permitted by FDA regulations.

A variety of soluble (fermentable) fiber sources can be used including, but not limited to, inulin, fructans, xanthan gum, cellulose, guar gum, fructooligosaccharides (FOS) and oligo- or polysaccharides.

### Lutein

Lutein has been found to lower the risk of cataracts and macular degeneration. Lutein may also help to prevent or slow down the thickening of arteries (development of atherosclerosis), which is a major risk for cardiovascular disease.

Lutein has been recognized as being a Generally Recognized as Safe (GRAS) substance. See for example FDA Agency Response Letter GRAS Notice No. GRN 000110; http://www.cfsan.fda.gov/˜rdb/opa-g1110.html) This GRAS Notice relates to a mixture of carotenoid xanthophyll esters that Cognis Corporation (Cognis) calls “lutein esters.” This GRAS notice indicates that lutein esters can be used at levels up to 4.0 mg per RACC (reference amounts customarily consumed per eating session). See also FDA Agency Response Letter GRAS Notice No. GRN 000140; http://www.cfsan.fda.gov/˜rdb/opa-g140.html) This GRAS Notice relates to a mixture of the carotenoids lutein and zeaxanthin referred to by Kemin Foods, L.C. as “crystalline lutein.” The GRAS notice indicates that crystalline lutein use level is up to 2.0 mg crystalline lutein per RACC.

### Flavors

A variety of flavorants can be incorporated into the compositions of this invention. The flavorants can be either natural or artificial. Examples of flavorants that can be added include, but are not limited to: onion and egg yolk. Other flavorants that may be used are found in the report of the Joint FAO/WHO Expert Committee on Food Additives, 63rd meeting, Geneva, 8-17 June, 2004 (See ftp://ftp.fao.org/es/esn/jecfa/jecfa63_summary.pdf)

### Colorants

A variety of colorants can incorporated into the compositions of the invention. The colorants can be either natural or artificial. The colorants can be used to simulate the color of egg yolks or other colors desired in a product made from the egg white composition of this invention.

### Use of Phytosterols in Food Compositions

A variety of foods containing added phytosterols are available in Europe, Asia and the US. These foods include margarines (such as the butter/margarine substitute Benecol™), mayonnaises, vegetable oils, salad dressings, yogurt, milk, soy milk, orange juice, snack bars and meats. In the United States, a panel of independent experts has concluded that vegetable oil sterol esters are considered GRAS for use as an ingredient in vegetable oil spreads in amounts not to exceed 20%. The FDA has approved spreads containing up to 20% of plant sterol ester and plant stanol ester, based on the GRAS recognition.

Phytosterols have a waxy consistency and a high melting point and a low solubility in water. These properties create solubility issues for the food processor. While they are oil-dispersible to some extent in their raw form, the amount required to produce an efficacious effect in a finished product can cause granulation. The most commonly used solution to this problem is to use esterified phytosterols which have different physical properties and are more soluble in liquid oil. Due to the physical property limitations of phytosterols, their use by food manufacturers has been limited to fat-based products like margarine, salad dressings and, most recently, snack bars.

### SUMMARY OF INVENTION

The present invention provides a novel manner of delivering phytosterols and/or omega-3 fatty acids, and or one or more of other materials or agents known to promote cardiovascular health and/or general health, in combination with liquid egg whites. This invention relates to liquid egg white products containing phytosterols and/or omega-3 fatty acids, and optionally one or more of the following components: at least one omega-3 fatty acid, vitamins, minerals, fiber, lutein, flavonoids (especially a polymethoxylated flavonoid-tocotrienol complex, such as one marketed by Source One Global under the tradename Sytrinol™) as well as other components recognized for reducing the levels of cholesterol in people and/or improving their health. This invention also relates to methods for producing liquid egg white products containing phytosterols and/or omega-3 fatty acids, and optionally one or more of the following components: at least one omega-3 fatty acid, vitamins, minerals, fiber, lutein, flavonoids (especially a polymethoxylated flavonoid-tocotrienol complex, such as one marketed by Source One Global under the tradename Sytrinol) as well as other components recognized for reducing the levels of cholesterol in people and/or improving their health.

### DETAILED DESCRIPTION OF THE INVENTION

Accordingly, in one aspect of the present invention, there is provided a food composition comprising liquid egg whites and at least one phytosterol and/or omega-3 fatty acids and optionally one or more of the following components: at least one omega-3 fatty acid, vitamins, minerals, fiber, lutein, flavonoids (especially a polymethoxylated flavonoid-tocotrienol complex, such as one marketed by Source One Global under the tradename Sytrinol™), where the food composition comprises about 90-99% by weight pasteurized egg whites. The at least one phytosterol, when present, is a free phytosterols, a phytosterol esters, or mixtures thereof. The amount of free phytosterols and esters thereof are present in the food composition in a combined amount of between 0.1%-3.0% by weight. However the total amount of free phytosterols and phytosterol esters is each no more than about 1.5%. All percentage used herein are percentages by weight relative to the total weight of the composition, unless other wise stated. In a preferred embodiment, the composition comprise at least at least one omega-3 fatty acid, especially eicosapentaenoic acid (EPA) and/or docosahexaenoic acid (DHA). α-linolenic acid (ALA) may also be used. In a preferred embodiment, eicosapentaenoic acid (EPA) and docosahexaenoic acid (DHA) can be used, either individually or together in the compositions of the invention. While fish oil is a primary source of omega-3 fatty acids, any source of omega-3 fatty acids, other sources of omega-3 fatty acids, such as algae, seal oil, flax oil, walnut oil and soybean oil, as well as mixtures of such omega-3 fatty acid sources may be employed. The omega-3 fatty acids are emulsified in the liquid egg white. Omega-3 fatty acids can be present at 100 to 300 mg per 100 g of total food composition. DHA and EPA can each be present at 30 to 115 mg per 100 g of total food composition.

The composition may also contain any flavonoid which has been shown to provide a health benefit to a person may be used. In a preferred embodiment the flavonoid is a polymethoxylated flavonoid-tocotrienol complex, such as one marketed by Source One Global under the tradename Sytrinol™.

Vitamins and minerals can be used individually or by using a premix of several vitamins and/or minerals. In a preferred embodiment of the invention, a mixture of vitamins and minerals is used. Vitamin E can be present in a variety of forms. In a preferred embodiment, vitamin E is present as alpha-tocopherol or alpha-tocopheryl acetate. Vitamin E can be present in an amount of about 0.01 to about 0.03 wt %.

Soluble fibers may be present in the composition. The soluble fibers useful in the invention include xanthan gum, guar gum, and fructans. Other soluble fiber sources may also be used. Soluble fibers may be present at amount of 2.5-7.5 g/60 g serving (one medium egg), or 4.1-12.3 g/100 g egg white product. Lutein may also be present in the composition, especially in the form of. Lutein may be present at amount up to about 4 mg/60 g serving (one medium egg), or about of 6.7 mg/100 g egg white product. Various natural and/or flavorants may be present in the composition. Such flavorants include, but are not limited to onions and egg yolk. Flavorants are generally used in amounts of about 0.02 to about 0.04 wt %.

Various other components may also be present. Lecithin may be added to the composition as an emulsifier to assist in binding the fish oil into the liquid egg. Generally, about 0.1 to about 0.2 wt % of lecithin may be used. Other food-grade surface active agents may be employed including emulsifiers and modified starch, trogacanth gum, trogacanth replacers.

For some uses of the product it is preferable to have a product similar in color to fresh eggs. For such uses a food-grade coloring may be added to provide a yellow color to the product. In an embodiment, beta carotene is used for this purpose and is present in an amount of about 0.04 to about 0.08 wt %. Other food-grade additives may be used to obtain similar results, including carrot extracts, anatto and various natural and synthetic colorants.

A thickening agent, which may be prehydrated xanthan gum, also may be added, generally in an amount up to about 1%. The xanthan gum also assists in particulate suspension and control of separation of oils and fats. The xanthan gum may be used in a blend with arabic gum. Other food-grade gums which may be used include guar, locust bean gum, karaya, carrageenans, arabic gum, agar gum, alginates, gum trogacanth, or blends of two or more of such gums.

The compositions described above can be produced by the following general process. A mixture of the dry ingredients of the composition, including free phytosterols (is used) is formed by combining the individual ingredients to form a pre-blend of free phytosterols and dry ingredients. A mixture of the omega-3 fatty acids, phytosterol esters, and liquid ingredients, except egg whites, is formed by combining the individual ingredients to form a pre-blend of free phytosterols and liquid ingredients. If the phytosterols are present as a mixture of free phytosterols and phytosterol esters, it is generally preferable to add such a mixture to the liquid pre-blend. However, depending upon the specific source of such a mixture of free phytosterols and phytosterol esters, it may be desirable to add such a mixture to the solid pre-blend in order to facilitate the mixing and dispersion required. One skilled in the art would be able to make such a determination based on the source of the mixture of free phytosterols and phytosterol esters. In forming each of the above pre-blends, the individual components of the pre-blend can be added and mixed either sequentially or simultaneously using techniques known to a person skilled in the art. A portion of the eggs whites, about 5% to about 50% of the total egg whites needed, is added to a mixer. Various types of mixers that provide the necessary shear or turbulence to form the composition may be used. Examples of such mixers are described in Perry's Chemical Engineers' Handbook, Seventh Edition, McGraw Hill (1997). The specific amount and nature of mixing required depends upon the specific mixing equipment being used. One skilled in the art would be able to make such a determination based on routine experimentation. In a preferred embodiment, the mixing forms a vortex of the egg whites in the mixer. The pre-blend of dry ingredients, including free phytosterols if present, is added to the egg whites. In a preferred embodiment, the pre-blend of dry ingredients, including free phytosterols if present, is added to a vortex of the egg whites. The resulting mixture is blended until the pre-blend is uniformly dispersed in the egg whites and the mixture is homogeneous. The remaining about 50% to 95% of the egg whites is added to the mixture. In a preferred remaining egg whites are added to the mixture while the mixture is present as a vortex in the mixer. The pre-blend of all liquid ingredients, including the omega-3 fatty acid and phytosterol esters, if present, is added to the mixture of all of the egg whites and the solid ingredients. In a preferred embodiment, the liquid pre-blend is added to the mixture while the mixture is present as a vortex in the mixer. The resulting mixture is blended until the resulting composition is homogeneous. In the above process, each of the pre-blends may be added to the material in the blender either in batch portions or in continuous portions added over a set time period. In a preferred embodiment the pre-blends are added while the mixture is continuously stirred.

Following completion of the blending in of the various components of the emulsified egg white product, the product may further be homogenized by applying physical forces to the product and then pasteurized. It is important to avoid separation of the added liquids, especially fish oil, from the egg white product to effect such homogenization, which may be effected at a pressure about 100 to about 2000 psi, preferably about 1400 psi, depending on the degree of homogeneity required. Such homogenization procedures are well known in the art and may be carried out on different types of equipment. The homogenization step reduces the particle size of suspended materials in the composition and the potential for separation of suspended materials from the composition. Higher pressures result in smaller particle sizes and permit longer production runs on different design equipment. The position and pressure used vary with the specific equipment used.

Following pasteurization, the liquid egg white product is cooled to refrigeration temperature (about 4° C.) and packaged. Alternatively, the liquid egg white product may first be packaged and then pasteurized or ultrapasteurized in the package. The liquid egg white product is stable at refrigerator temperatures for a period of at least 90 days.

The liquid egg white product may be used in cooked frozen egg pastries, omelettes and other similar frozen products. The product provided herein may also be employed in producing a variety of food products, such as cake mixes.

### DESCRIPTION OF PREFERRED EMBODIMENTS

In a preferred embodiment, a food composition comprises pasteurized egg whites and at least one phytosterol, wherein the at least one phytosterol is selected from the group consisting of free phytosterols and phytosterol esters, and at least one omega-3 fatty acid. In another embodiment, a food composition comprises pasteurized egg whites, at least one phytosterol, an omega-3 fatty acid and fiber. In a still further embodiment, a food composition comprises pasteurized egg whites, at least one phytosterol and at least one omega-3 fatty acid and/or a polymethoxylated flavonoid-tocotrienol complex, such as one marketed by Source One Global under the tradename Sytrinol™. In an embodiment, a food composition comprises pasteurized egg whites, at least one phytosterol and/or a polymethoxylated flavonoid-tocotrienol complex and also comprises vitamin E. In another embodiment, a food composition comprises pasteurized egg whites, at least one phytosterol and/or a polymethoxylated flavonoid-tocotrienol complex and further comprises lutein. In further embodiment, a food composition comprises pasteurized egg whites, at least one phytosterol and/or a polymethoxylated flavonoid-tocotrienol complex and further comprises at least one other component known to be effective in promoting good health.

In another preferred embodiment, a food composition comprises pasteurized egg whites, at least one phytosterol and/or a polymethoxylated flavonoid-tocotrienol complex, and further comprises fiber and at least one omega-3 fatty acid. In a further preferred embodiment, any of the above food compositions further comprise vitamin E. In a further preferred embodiment, any of the above food compositions further comprise lutein. In a still further preferred embodiment, any of the above food compositions further comprises at least one other component known to be effective in promoting good health. In a further preferred embodiment, the at least one other component known to be effective in promoting good health is a vitamin, a mineral, a flavonoid, or complexes/mixture thereof.

In a preferred embodiment, the at least one omega-3 fatty acid in any of the above food compositions is selected from the group consisting of eicosapentaenoic acid (EPA) and/or docosahexaenoic acid (DHA).

In a preferred embodiment, the egg whites in any of the above food compositions comprise between about 90-99% by weight of the composition.

In a still further preferred embodiment, the free phytosterols and esters thereof are present in a combined amount of at least about 0.1% by weight, wherein the total amount of free phytosterols present is no more than about 1.5% and the total amount of phytosterol esters present is no more than about 1.5%, each percentage by weight being relative to the total weight of the composition. In a preferred embodiment, the amount of at least one omega-3 fatty acids comprises between about 100 to 300 mg/100 g of composition. In another preferred embodiment, the at least one omega-3 fatty acid is eicosapentaenoic acid (EPA) and/or docosahexaenoic acid (DHA) and each of these omega-3 fatty acids comprises about 30 to 115 mg/100 g of composition.

In a preferred embodiment a food composition comprises the following components, wherein the components are present in about the cited masses:

| | Mass of component |
|---|---|
| Component | per 100 g of composition |
| Pasteurized Egg Whites | 90-99% by weight |
| Plant sterols | 0.1 to 1.5 g |
| Plant sterol esters | 0.1 to 1.5 g |
| At least one omega-3 fatty acid | 100 to 300 mg |
| DHA | 30 to 115 mg |
| EPA | 30 to 115 mg |
| Fat | 0 to 3 g |
| Natural flavors | 0 to 3 g |
| Guar gum | 0 to 1 g |
| Xanthum gum | 0 to 1 g |
| Lecithin | 0 to 0.5 g |
| Vitamins and/or Minerals | 0 to 0.5 g |
| Lutein | 0 to 300 μg |
| Fiber | 0 to 12.5 g |
| flavonoid-tocotrienol complex | 0 to 0.3 g |
| (Sytrinol ™) | |

In another preferred embodiment a food composition comprises the following components, wherein the components are present in about the cited masses:

| | Mass of component | |
|---|---|---|
| Component | per 100 g of composition | |
| Pasteurized Egg Whites | 90-99% | by weight |
| Plant sterols | 0.1 to 1.5 | g |
| Plant sterol esters | 0 to 1.5 | g |
| At least one omega-3 fatty acid | 100 to 300 | mg |
| DHA | 30 to 115 | mg |
| EPA | 30 to 115 | mg |
| Fat | 0 to 3 | g |
| Natural flavors | 0 to 3 | g |
| Guar gum | 0 to 1 | g |
| Xanthum gum | 0 to 1 | g |
| Lecithin | 0 to 0.5 | g |
| Vitamins and/or Minerals | 0 to 0.5 | g |
| Lutein | 0 to 300 | μg |
| Fiber | 0 to 12.5 | g |
| flavonoid-tocotrienol complex | 0 to 0.3 | g |
| (Sytrinol ™) | | |

In a preferred embodiment a food composition comprises the following components, wherein the components are present in about the cited masses:

| | Mass of component | |
|---|---|---|
| Component | per 100 g of composition | |
| Pasteurized Egg Whites | 90-99% | by weight |
| Plant sterols | 0 to 1.5 | g |
| Plant sterol esters | 0.1 to 1.5 | g |
| At least one omega-3 fatty acid | 100 to 300 | mg |
| DHA | 30 to 115 | mg |
| EPA | 30 to 115 | mg |
| Fat | 0 to 3 | g |
| Natural flavors | 0 to 3 | g |
| Guar gum | 0 to 1 | g |
| Xanthum gum | 0 to 1 | g |
| Lecithin | 0 to 0.5 | g |
| Vitamins and/or Minerals | 0 to 0.5 | g |
| Lutein | 0 to 300 | μg |
| Fiber | 0 to 12.5 | g |
| flavonoid-tocotrienol complex | 0 to 0.3 | g |
| (Sytrinol ™) | | |

In a preferred embodiment any of the food composition described above are stable at refrigerator temperatures for a period of at least 90 days.

In another preferred embodiment any of the food compositions described above further comprise at least one component providing a flavor to the food composition. In a preferred embodiment the flavor provided to the food composition is an onion flavor. In another preferred embodiment the flavor provided to the food composition is the flavor of egg yolk.

In another preferred embodiment, any of the food compositions described above is pasteurized. In a further preferred embodiment, any of the food compositions described above is ultrapasteurized.

In order to further illustrate the present invention and the advantages thereof, the following specific examples are given, it being understood that they are intended only as illustrative and in no way limitative.

### Examples of Compositions

Example 1 describes a liquid egg white product composition comprising pasteurized egg whites and phytosterols in accordance with one aspect of the invention.

### Example 1

| | Mass of component | |
|---|---|---|
| Component | per 100 g of composition | |
| Pasteurized Egg Whites | 90-99% | by weight |
| Phytosterols | 0.1 to 3 g total (free + ester), with no | |
| | more | |
| | than 1.5 g of each form | |
| Fat | 0 to 3 | g |
| Natural flavors | 0 to 3 | g |
| Guar gum | 0 to 1 | g |
| Xanthum gum | 0 to 1 | g |
| Lecithin | 0 to 0.5 | g |

Example 2 describes a liquid egg white product composition comprising pasteurized egg whites, phytosterols and fiber in accordance with one aspect of the invention.

### Example 2

| | Mass of component | |
|---|---|---|
| Component | per 100 g of composition | |
| Pasteurized Egg Whites | 90-99% | by weight |
| Phytosterols | 0.1 to 3 g total (free + ester), with no | |
| | more | |
| | than 1.5 g of each form | |
| Fat | 0 to 3 | g |
| Natural flavors | 0 to 3 | g |
| Guar gum | 0 to 1 | g |
| Xanthum gum | 0 to 1 | g |
| Lecithin | 0 to 0.5 | g |
| Vitamins and/or Minerals | 0 to 0.5 | g |
| Fiber | 0.1-12.5 | g |

Example 3 describes a liquid egg white product composition comprising pasteurized egg whites, phytosterols, fiber and at least one omega-3 fatty acid in accordance with one aspect of the invention.

### Example 3

| | Mass of component | |
|---|---|---|
| Component | per 100 g of composition | |
| Pasteurized Egg Whites | 90-99% | by weight |
| Phytosterols | 0.1 to 3 g total (free + ester), with | |
| | no more than 1.5 g of each form | |
| At least one omega-3 fatty acid | 100 to 300 mg (total of all | |
| | omega-3 fatty acids) | |
| DHA | 30 to 115 | mg |
| EPA | 30 to 115 | mg |
| Fat | 0 to 3 | g |
| Natural flavors | 0 to 3 | g |
| Guar gum | 0 to 1 | g |
| Xanthum gum | 0 to 1 | g |
| Lecithin | 0 to 0.5 | g |
| Vitamins and/or Minerals | 0 to 0.5 | g |
| Fiber | 0.1-12.5 | g |

Example 4 describes a liquid egg white product composition comprising pasteurized egg whites, phytosterols, fiber, at least one omega-3 fatty acid and vitamin E in accordance with one aspect of the invention.

### Example 4

| | Mass of component | |
|---|---|---|
| Component | per 100 g of composition | |
| Pasteurized Egg Whites | 90-99% | by weight |
| Phytosterols | 0.1 to 3 g total (free + ester), with | |
| | no more than 1.5 g of each form | |
| At least one omega-3 fatty acid | 100 to 300 | mg |
| DHA | 30 to 115 | mg |
| EPA | 30 to 115 | mg |
| Fat | 0 to 3 | g |
| Natural flavors | 0 to 3 | g |
| Guar gum | 0 to 1 | g |
| Xanthum gum | 0 to 1 | g |
| Lecithin | 0 to 0.5 | g |
| Vitamins and/or Minerals | 0 to 0.5 | g |
| Vitamin E | 50 to 666 IU (33-447 mg as alpha- | |
| | tocopherol) | |
| Lutein | 0.01-3.5 | mg |
| Fiber | 0.1-12.5 | g |

Example 5 describes a liquid egg white product composition comprising pasteurized egg whites, phytosterols and other components known to be effective in promoting good health in accordance with one aspect of the invention.

### Example 5

| | Mass of component | |
|---|---|---|
| Component | per 100 g of composition | |
| Pasteurized Egg Whites | 90-99% | by weight |
| At least one omega-3 fatty acid | 100 to 300 | mg |
| DHA | 30 to 115 | mg |
| EPA | 30 to 115 | mg |
| Phytosterols | 0.1 to 3 g total (free + ester), with | |
| | no more than 1.5 g of each form | |
| Fat | 0 to 3 | g |
| Natural flavors | 0 to 3 | g |
| Guar gum | 0 to 1 | g |
| Xanthum gum | 0 to 1 | g |
| Lecithin | 0 to 0.5 | g |
| Vitamins and/or Minerals | 0 to 0.5 | g |
| Lutein | 0.01-3.5 | mg |
| Fiber | 0.1-12.5 | g |
| polymethoxylated | 0-0.3 | g |
| flavonoid-tocotrienol complex | | |
| (Sytrinol ™.) | | |

Examples of preferred embodiments of the invention are described below.

### Example 6

### Liquid Egg Product with Omega-3's and Phytosterols

| | % Composition |
|---|---|
| Ingredient | by Weight |
| Pasteurized Liquid Egg White | 95.995 |
| Vitamin Premix | 0.565 |
| Stabilizer XC-8444 Powder | 0.35 |
| Annatto, 03193 NOL | 0.01 |
| Denomega 100 | 1.00 |
| Soy Lecithin Yelkin 1018 | 0.08 |
| Nat. Egg Type Fl. #2562L19381 | 0.04 |
| Salt | 0.30 |
| Onion Powder | 0.20 |
| Butter Buds, High Conc. | 0.36 |
| CoroWise ES-200 | 1.10 |
| | 100.00 |

Per Serving:
DHA - 84 mg
EPA - 84 mg
Total Omega 3 - 216 mg
Phytosterols - 0.43 g.
Vitamins equivalent to whole egg

### Example 7

### Liquid Egg Product with Omega-3's and Phytosterols

| | % Composition |
|---|---|
| Ingredient | by Weight |
| Pasteurized Liquid Egg White | 96.77 |
| Vitamin Premix Nutri-Mix CB# 07270700 | 0.20 |
| Stabilizer XC-8444 Powder | 0.35 |
| Denomega 100 | 0.50 |
| Soy Lecithin Yelkin 1018 | 0.08 |
| Nat. Egg Type Fl. #2562L19381 | 0.04 |
| Salt | 0.33 |
| Onion Powder | 0.25 |
| Butter Buds, High Conc. | 0.38 |
| CoroWise ES-200 | 1.10 |
| | 100.00 |

Per Serving:
DHA - 42 mg
EPA - 42 mg
Total Omega 3 - 108 mg
Phytosterols - 0.43 g.
Vitamins similar to egg beaters

### Example 8

### Liquid Egg Product with Omega-3's and Phytosterols

| | % Composition |
|---|---|
| Ingredient | by Weight |
| Pasteurized Liquid Egg White | 96.27 |
| Vitamin Premix Nutri-Mix CB# 07270700 | 0.20 |
| Stabilizer XC-8444 Powder | 0.35 |
| Denomega 100 | 1.00 |
| Soy Lecithin Yelkin 1018 | 0.08 |
| Nat. Egg Type Fl. #2562L19381 | 0.04 |
| Salt | 0.33 |
| Onion Powder | 0.25 |
| Butter Buds, High Conc. | 0.38 |
| CoroWise ES-200 | 1.10 |
| | 100.00 |

Per Serving:
DHA - 84 mg
EPA - 84 mg
Total Omega 3 - 216 mg
Phytosterols - 0.43 g.
Vitamins similar to egg beaters

### Example 9

### Liquid Egg Product with Omega-3's

| | % Composition |
|---|---|
| Ingredient | by Weight |
| Pasteurized Liquid Egg White | 97.87 |
| Vitamin Premix Nutri-Mix CB# 07270700 | 0.20 |
| Stabilizer XC-8444 Powder | 0.35 |
| Denomega 100 | 0.50 |
| Soy Lecithin Yelkin 1018 | 0.08 |
| Nat. Egg Type Fl. #2562L19381 | 0.04 |
| Salt | 0.33 |
| Onion Powder | 0.25 |
| Butter Buds, High Conc. | 0.38 |
| | 100.00 |

Per Serving:
DHA - 42 mg
EPA - 42 mg
Total Omega 3 - 108 mg
Vitamins similar to egg beaters

### Example 10

### Liquid Egg Product with Phytosterols

| | % Composition |
|---|---|
| Ingredient | by Weight |
| Pasteurized Liquid Egg White | 97.35 |
| Vitamin Premix Nutri-Mix CB# 07270700 | 0.20 |
| Stabilizer XC-8444 Powder | 0.35 |
| Nat. Egg Type Fl. #2562L19381 | 0.04 |
| Salt | 0.33 |
| Onion Powder | 0.25 |
| Butter Buds, High Conc. | 0.38 |
| CoroWise ES-200 | 1.10 |
| | 100.00 |

Per Serving:
Phytosterols - 0.43 g.

### Example 11

### Liquid Egg Product with Omega-3's, Fiber and Phytosterols

| | % Composition |
|---|---|
| Ingredient | by Weight |
| Pasteurized Liquid Egg White | 92.68 |
| Vitamin Premix Nutri-Mix CB# 07270700 | 0.25 |
| Stabilizer XC-8444 Powder | 0.35 |
| Denomega 100 | 0.50 |
| Soy Lecithin Yelkin 1018 | 0.08 |
| Nat. Egg Type Fl. #2562L19381 | 0.04 |
| Salt | 0.33 |
| Onion Powder | 0.35 |
| Butter Buds, High Conc. | 0.40 |
| CoroWise ES-200 | 1.10 |
| Nutriose FM06 | 3.92 |
| | 100.00 |

Per Serving:
DHA - 42 mg
EPA - 42 mg
Total Omega 3 - 108 mg
Phytosterols - 0.43 g.
Soluble Fiber - 2 g.

### Example 12

### Liquid Egg Product with Omega-3's and Fiber

| | % Composition |
|---|---|
| Ingredient | by Weight |
| Pasteurized Liquid Egg White | 93.90 |
| Vitamin Premix Nutri-Mix CB# 07270701 | 0.25 |
| Stabilizer XC-8444 Powder | 0.35 |
| Denomega 100 | 0.50 |
| Soy Lecithin Yelkin 1018 | 0.08 |
| Nat. Egg Type Fl. #2562L19381 | 0.04 |
| Salt | 0.33 |
| Onion Powder | 0.25 |
| Butter Buds, High Conc. | 0.38 |
| Nutriose FM06 | 3.92 |
| | 100.00 |

Per Serving (60 grams):
DHA - 42 mg
EPA - 42 mg
Total Omega 3 - 108 mg
Soluble Fiber: 2 g.

### Example 13

### Liquid Egg Product with Omega-3′ and Egg Flavorant

| | % Composition |
|---|---|
| Ingredient | by Weight |
| Raw Liquid Egg White | 96.65 |
| Vitamin Premix Nutri-Mix CB# 07270701 | 0.20 |
| Stabilizer XC-8444 Powder | 0.23 |
| Salt | 0.33 |
| Onion Powder | 0.23 |
| Butter Buds, High Concentrate Uncolored. | 0.34 |
| CoroWise ES-200 (Phytosterol) | 1.27 |
| Nisin - Nisaplin | 0.02 |
| Omege 3 - RO200 | 0.607 |
| Soy Lecithin Yelkin 1018 | 0.08 |
| Nat. Egg Type Fl. #2562L19381 | 0.04 |
| | 100.00 |

### Examples of Methods of Preparing the Compositions

Example 14 describes a method of preparing a liquid egg white product composition comprising phytosterols in accordance with one aspect of the invention.

### Example 14

A pre-blend of phytosterols and dry ingredients is formed. A pre-blend of at least one omega-3 fatty acid and all liquids, except egg whites, is formed. About 5% to 50% of the egg whites are added to a mixer, then a vortex is created in the egg whites in the mixer. The pre-blend of phytosterols and dry ingredients is then added to the vortex of the egg whites. The resulting composition is mixed until the pre-blend is uniformly dispersed in the egg whites and the mixture is homogeneous. The remaining about 50% to 95% of the egg whites are added to the mixture while the mixture is present as a vortex in the mixer. The pre-blend of least one omega-3 fatty acid and all liquids, except the egg whites, is added to the mixture while the mixture is present as a vortex in the mixer. The composition is mixed until the liquid pre-blend is uniformly dispersed in the mixture.

Example 15 describes a method of preparing a liquid egg white product composition comprising free phytosterols in accordance with one aspect of the invention.

### Example 15

A pre-blend of free phytosterols and dry ingredients is formed. A pre-blend of all liquids, except egg whites, is formed. About 5% to 50% of the egg whites are added to a mixer, then a vortex is created in the egg whites in the mixer. The pre-blend of free phytosterols and dry ingredients is then added to the vortex of the egg whites. The resulting composition is mixed until the pre-blend is uniformly dispersed in the egg whites and the mixture is homogeneous. The remaining about 50% to 95% of the egg whites are added to the mixture while the mixture is present as a vortex in the mixer. The pre-blend of all liquids, except the egg whites, is added to the mixture while the mixture is present as a vortex in the mixer. The composition is mixed until the liquid pre-blend is uniformly dispersed in the mixture.

Example 16 describes a method of preparing a liquid egg white product composition comprising free phytosterols and an omega-3 fatty acid in accordance with one aspect of the invention.

### Example 16

A pre-blend of free phytosterols and dry ingredients is formed. A pre-blend of at least one omega-3 fatty acid and all liquids, except egg whites, is formed. About 5% to 50% of the egg whites are added to a mixer, then a vortex is created in the egg whites in the mixer. The pre-blend of free phytosterols and dry ingredients is then added to the vortex of the egg whites. The resulting composition is mixed until the pre-blend is uniformly dispersed in the egg whites and the mixture is homogeneous. The remaining about 50% to 95% of the egg whites are added to the mixture while the mixture is present as a vortex in the mixer. The pre-blend of least one omega-3 fatty acid and all liquids, except the egg whites, is added to the mixture while the mixture is present as a vortex in the mixer. The composition is mixed until the liquid pre-blend is uniformly dispersed in the mixture.

Example 17 describes a method of preparing a liquid egg white product composition comprising a phytosterol ester in accordance with one aspect of the invention.

### Example 17

A pre-blend dry ingredients is formed. A pre-blend of a phytosterol ester and all liquids, except egg whites, is formed. About 5% to 50% of the egg whites are added to a mixer, then a vortex is created in the egg whites in the mixer. The pre-blend of dry ingredients is then added to the vortex of the egg whites. The resulting composition is mixed until the pre-blend is uniformly dispersed in the egg whites and the mixture is homogeneous. The remaining about 50% to 95% of the egg whites are added to the mixture while the mixture is present as a vortex in the mixer. The pre-blend of a phytosterol ester and all liquids, except the egg whites, is added to the mixture while the mixture is present as a vortex in the mixer. The composition is mixed until the liquid pre-blend is uniformly dispersed in the mixture.

Example 18 describes a method of preparing a liquid egg white product composition comprising a phytosterol ester and an omega-3 fatty acid in accordance with one aspect of the invention.

### Example 18

A pre-blend of dry ingredients is formed. A pre-blend of a phytosterol ester, at least one omega-3 fatty acid and all liquids, except egg whites, is formed. About 5% to 50% of the egg whites are added to a mixer, then a vortex is created in the egg whites in the mixer. The pre-blend of dry ingredients is then added to the vortex of the egg whites. The resulting composition is mixed until the pre-blend is uniformly dispersed in the egg whites and the mixture is homogeneous. The remaining about 50% to 95% of the egg whites are added to the mixture while the mixture is present as a vortex in the mixer. The pre-blend of a phytosterol ester, at least one omega-3 fatty acid and all liquids, except the egg whites, is added to the mixture while the mixture is present as a vortex in the mixer. The composition is mixed until the liquid pre-blend is uniformly dispersed in the mixture.

Example 19 describes a method of preparing a liquid egg white product composition comprising a free phytosterol and a phytosterol ester in accordance with one aspect of the invention.

### Example 19

A pre-blend of free phytosterols and dry ingredients is formed. A pre-blend of a phytosterol ester and all liquids, except egg whites, is formed. About 5% to 50% of the egg whites are added to a mixer, then a vortex is created in the egg whites in the mixer. The pre-blend of free phytosterols and dry ingredients is then added to the vortex of the egg whites. The resulting composition is mixed until the pre-blend is uniformly dispersed in the egg whites and the mixture is homogeneous. The remaining about 50% to 95% of the egg whites are added to the mixture while the mixture is present as a vortex in the mixer. The pre-blend of a phytosterol ester and all liquids, except the egg whites, is added to the mixture while the mixture is present as a vortex in the mixer. The composition is mixed until the liquid pre-blend is uniformly dispersed in the mixture.

Example 20 describes a method of preparing a liquid egg white product composition comprising free phytosterols, a phytosterol ester and an omega-3 fatty acid in accordance with one aspect of the invention.

### Example 20

A pre-blend of free phytosterols and dry ingredients is formed. A pre-blend of a phytosterol ester, at least one omega-3 fatty acid and all liquids, except egg whites, is formed. About 5% to 50% of the egg whites are added to a mixer, then a vortex is created in the egg whites in the mixer. The pre-blend of free phytosterols and dry ingredients is then added to the vortex of the egg whites. The resulting composition is mixed until the pre-blend is uniformly dispersed in the egg whites and the mixture is homogeneous. The remaining about 50% to 95% of the egg whites are added to the mixture while the mixture is present as a vortex in the mixer. The pre-blend of a phytosterol ester, at least one omega-3 fatty acid and all liquids, except the egg whites, is added to the mixture while the mixture is present as a vortex in the mixer. The composition is mixed until the liquid pre-blend is uniformly dispersed in the mixture.

Each patent, patent application, publication, text and literature article/report cited or indicated herein is hereby expressly incorporated by reference in its entirety.

While the invention has been described in terms of various specific and preferred embodiments, the skilled artisan will appreciate that various modifications, substitutions, omissions, and changes may be made without departing from the spirit thereof. Accordingly, it is intended that the scope of the present invention be limited solely by the scope of the following claims, including equivalents thereof.

What we claim is:

1. A food composition comprising: (1) pasteurized egg whites and (2) at least one member selected from the group consisting of at least one phytosterol and at least one omega-3 fatty acid, wherein the at least one phytosterol is selected from the group consisting of free phytosterols and phytosterol esters.

2. The food composition of claim 1, further comprising at least one member selected from the group consisting of fibers, a polymethoxylated flavonoid-tocotrienol complex, vitamins, lutein, minerals, flavonoids, zeaxanthin, at least one component providing the flavor of egg yolk and complexes/mixtures of vitamins, minerals and flavonoids.

3. The food composition of claim 1, wherein the at least one omega-3 fatty acid is selected from the group consisting of eicosapentaenoic acid (EPA) and docosahexaenoic acid (DHA).

4. A food composition comprising: (1) pasteurized egg whites (2) at least one phytosterol and (3) at least one omega-3 fatty acid, wherein the at least one phytosterol is selected from the group consisting of free phytosterols and phytosterol esters.

5. The food composition of claim 4, further comprising at least one member selected from the group consisting of fibers, a polymethoxylated flavonoid-tocotrienol complex, vitamins, lutein, minerals, flavonoids, zeaxanthin, at least one component providing the flavor of egg yolk and complexes/mixtures of vitamins, minerals and flavonoids.

6. The food composition of claim 1, having at least one of the following features:
(a) the egg whites comprise between about 90-99% by weight of the composition;
(b) the at least one phytosterol is selected from the group consisting of free phytosterols and esters thereof, the free phytosterols and esters thereof being present in a combined amount of at least about 0.1% by weight, wherein the total amount of free phytosterols present is no more than about 1.5% and the total amount of phytosterol esters present is no more than about 1.5%, each percentage by weight being relative to the total weight of the composition;
(c) the at least one omega-3 fatty acid comprises between about 100 to 300 mg/100 g of composition; and
(d) the at least one omega-3 fatty acid is eicosapentaenoic acid (EPA) and/or docosahexaenoic acid (DHA) and EPA and DHA, and each of these omega-3 fatty acids comprises about 30 to 300 mg/100 g of composition.

7. The food composition of claim 1, wherein the food composition is stable at refrigerator temperatures for a period of at least 90 days and/or wherein the composition is pasteurized or ultrapasteurized.

8. A method of forming the food composition of claim 1, the method comprising the steps of:
a. forming a pre-blend of the dry ingredients, wherein when the composition comprises free phytosterols, the free phytosterols are included in the pre-blend with the dry ingredients,
b. forming a pre-blend of all liquids except egg whites, wherein when the composition comprises phytosterol esters and/or at least one omega-3 fatty acid, the phytosterol esters and/or at least one omega-3 fatty acid are included in the pre-blend with the liquids,
c. adding from about 5% to 50% of the egg whites to a mixer,
d. providing sufficient mixing force in said mixer to create sufficient shear or turbulence such that a stable homogeneous composition is present at the completion of step f,
e. adding the pre-blend of dry ingredients to the mixing egg whites,
f. mixing the composition formed in step e until the pre-blend of dry ingredients is uniformly dispersed in the egg whites and the mixture is homogeneous,
g. adding the remaining about 50% to 95% of the egg whites to the mixture formed in step f while the mixture is continuously mixed,
h. adding the pre-blend of all liquids except egg whites to the mixture formed in step g while the mixture is continuously mixed,
i. mixing the composition formed in step h until the pre-blend is uniformly dispersed in the mixture formed in step h and the mixture is homogeneous.

9. The method of claim 8, wherein in step (d), the mixing force creates a vortex in the egg whites and in step (e), the pre-blend dry ingredients is added to the mixing egg whites while the mixture is present as a vortex in the mixer.

10. A method of forming the food composition of claim 1, the method comprising the steps of:
a. forming a pre-blend of the dry ingredients, wherein when the composition comprises free phytosterols, the free phytosterols are included in the pre-blend with the dry ingredients,
b. forming a pre-blend of all liquids except egg whites, wherein when the composition comprises phytosterol esters and/or at least one omega-3 fatty acid, the phytosterol esters and/or at least one omega-3 fatty acid are included in the pre-blend with the liquids,
c. adding from about 5% to 50% of the egg whites to a mixer,
d. providing sufficient mixing force in said mixer to create sufficient shear or turbulence such that a stable homogeneous composition is present at the completion of step f,
e. adding the pre-blend of dry ingredients to the mixing egg whites,
f. mixing the composition formed in step e until the pre-blend of dry ingredients is uniformly dispersed in the egg whites and the mixture is homogeneous,
g. adding the remaining about 50% to 95% of the egg whites to the mixture formed in step f while the mixture is mixing,
h. adding the pre-blend of all liquids except egg whites to the mixture formed in step g while the mixture is mixing,
i. mixing the composition formed in step h until the pre-blend is uniformly dispersed in the mixture formed in step h and the mixture is homogeneous.

11. The method of claim 10, wherein in step (d), the mixing force creates a vortex in the egg whites and in step (e), the pre-blend dry ingredients is added to the mixing egg whites while the mixture is present as a vortex in the mixer.
